(19) United States
(12) Patent Application Publication
(10) Pub. No.: US 2018/0192373 A1
(43) Pub. Date: Jul. 5, 2018

(54) ENHANCED LOW-POWER WAKEUP RADIO PACKET FOR LOW-POWER RADIOS AND NON-LOW POWER RADIOS

(71) Applicant: Intel Corporation, Santa Clara, CA (US)

(72) Inventors: Juan FANG, Hillsboro, OR (US); Minyoung Park, Portland, OR (US)

(21) Appl. No.: 15/394,316

(22) Filed: Dec. 29, 2016

(51) Int. Cl. H04W 52/02; H04L 5/00; H04W 84/12

(52) U.S. Cl. CPC H04W 52/0235; H04W 84/12; H04L 5/0055

(57) ABSTRACT

A device is disclosed, wherein the device comprises a memory and processing circuitry configured to determine that a first radio, connected to a first low power wake up receiver (LP-WUR) in a second device is to be powered on. The processing circuity may be configured to modulate a bit corresponding to a power on signal with an orthogonal frequency division multiplexing (OFDM) symbol corresponding to data packet, wherein the power on signal corresponds to a signal that will power on the first radio in the second device. The processing circuity may be configured to generate a LP-WUR packet comprising a preamble and payload, wherein the payload comprises the bit modulated with the symbol, and the preamble comprises a signal field indicating the packet type. The processing circuitry may be configured to cause to send the LP-WUR packet to the first LP-WUR radio and a third device.

### TECHNICAL FIELD

This disclosure generally relates to systems and methods for wireless communications and, more particularly, using orthogonal frequency division multiplexing (OFDM) symbols to modulate bit sequences of low power wakeup radio (LP-WUR) packets.

### BACKGROUND

Small computing devices such as wearable devices and sensors may be constrained by their small battery capacity but still need to support wireless communications technologies such as Wi-Fi or Bluetooth (BT) to connect to other computing devices (e.g., smartphone) and exchange data. This consumes power and it is critical to minimize energy consumption of such communications block in a wearable device.

### BRIEF DESCRIPTION OF THE DRAWINGS

FIG. 1 depicts a low power wake up radio (LP-WUR) and a non-(LP-WUR), according to one or more example embodiments of the disclosure.

FIG. 2 depicts an illustrative LP-WUR wakeup packet, according to one or more example embodiments of the disclosure.

FIG. 3 depicts an illustrative LP-WUR wakeup packet, according to one or more example embodiments of the disclosure.

FIG. 4 depicts an illustrative modulation of a wakeup signal with an orthogonal frequency division multiplexing (OFDM) symbol, according to one or more example embodiments of the disclosure.

FIG. 5 depicts an illustrative timing diagram of the transmission of a LP-WUR to LP-WURs and non-LP-WURs, according to one or more example embodiments of the disclosure.

FIG. 6 depicts an illustrative flow diagram for encapsulating a frame, according to one or more example embodiments of the disclosure.

FIG. 7 depicts an illustrative flow diagram for encapsulating a frame, according to the disclosure.

FIG. 8 depicts an illustrative flow diagram for ordering packets, according to the disclosure.

FIG. 9 illustrates a functional diagram of an example communication station that may be suitable for use as a user device, in accordance with one or more example embodiments of the disclosure.

FIG. 10 is a block diagram of an example machine upon which any of one or more techniques (for example, methods) may be performed, in accordance with one or more embodiments of the disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The pervasiveness of small battery constrained devices that are traditionally equipped with low power radios, are increasingly being equipped with Wi-Fi radios. Wi-Fi radios require more power than low power radios and therefore have to be shut off when not in use. However, because current applications being executed on these battery constrained devices, and future applications that have yet to be developed, are projected to require more bandwidth, and therefore will require larger bandwidth radios such as Wi-Fi radios, the Wi-Fi radios must be power cycled in such a way to maximize the amount of time between when the battery constrained devices must be recharged. In other words, a sleep/wake cycle must be implemented by the Wi-Fi radios that maximizes the amount of time that the battery constrained devices can be used without being recharged. This may be achieved when a low power radio receives a low-power wake up signal (e.g., a frame) that causes the low power radio to power on a corresponding Wi-Fi radio, thereby reducing the amount of power consumed by the Wi-Fi radio.

Because new battery constrained devices are being equipped with Wi-Fi radios, the Wi-Fi radios must compete with other non-battery constrained devices that are equipped with Wi-Fi radios to access the channel to send and/or receive data. When a non-wearable wireless device (e.g., a wireless device) has data to send to a wearable device, the non-wearable device must reserve a period of time to access the channel to transmit a wakeup signal to the wearable device and may only transmit the wakeup signal to the wearable device during the reserved period of time. This may increase the latency associated with applications, executing on the non-wearable device, that need to transmit data to other devices (e.g., APs) because the channel is reserved only to transmit the wakeup signal to the wearable device. One way to reduce the latency experienced by the applications executing on the non-wearable device, is to modulate the wakeup signal with signals corresponding to symbols carrying data associated with the executing applications, so that the wakeup signal can be sent to the wearable device while the data associated with the executing applications may be simultaneously transmitted to the APs. The wearable device and AP may both receive the wakeup signal and the data associated with the executing applications, but the wearable device may discard the data associated with the executing applications and the AP may ignore the wakeup signal.

As the number of wireless devices that include low power radios, and in particular low power wakeup radios (LP-WUR) increases, for example with battery operated Internet of Thing (IoT) devices, the number of wakeup signals transmitted may increase substantially thereby further increasing latency experienced by non-low power radio devices. Accordingly, systems, methods, and devices are necessary to alleviate the latency constraints that may be experienced by wireless devices comprising non-low power radios. The systems, methods, and devices disclosed herein alleviate these latency constraints and also enable the efficient use of time resources because a single packet can be used to transmit the wakeup signals to a first device and data signals to a second device associated with applications running on a device transmitting the wakeup signals and data signals. The systems, methods, and devices described herein also use the same frequency resource to send the wakeup signals and data signals. Thus the systems, methods, and devices disclosed herein make efficient use of time-frequency resources.

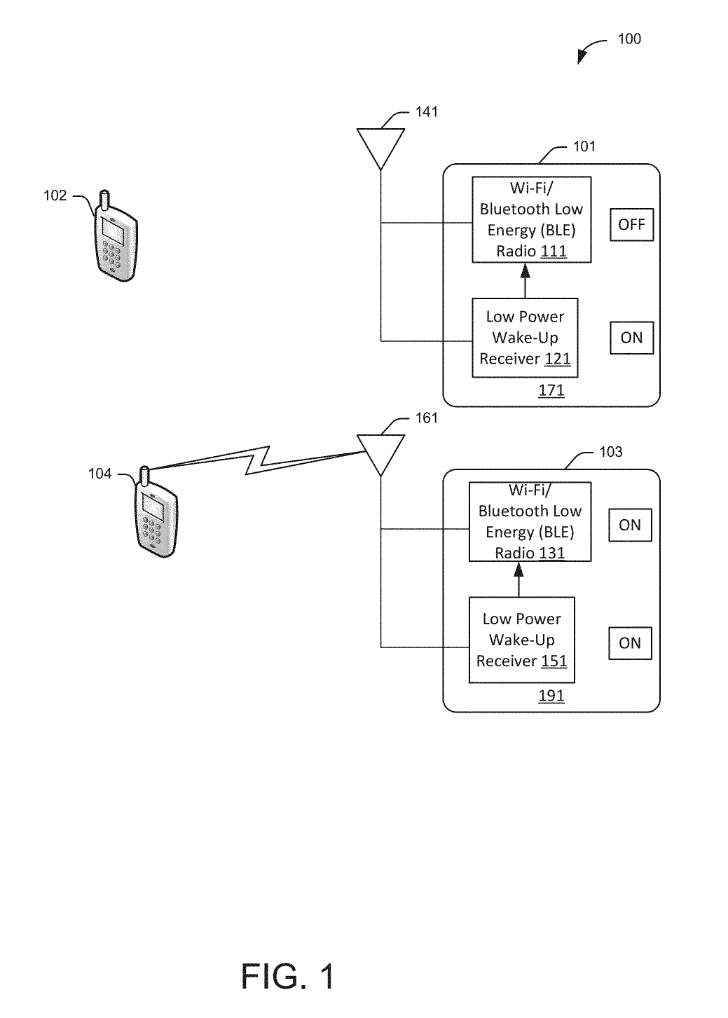

FIG. 1 depicts a low power wake up radio (LP-WUR) (e.g., Low Power Wake-Up Receiver 121 and Low Power Wake-Up Receiver 151) and a non-LP-WUR (e.g., Wi-Fi/Bluetooth Low Energy (BLE) Radio 111 and Wi-Fi/Bluetooth Low Energy (BLE) Radio 131). Wireless device 102 may be a smart phone comprising a Wi-Fi radio and/or Bluetooth Low Energy (BLE) radio that may transmit and receive signals to wireless device 101. When wireless device 102 is not transmitting signals to wireless device 101, Wi-Fi/BLE Radio 111 may be powered off, but Low Power Wake-Up Receiver 121 may still be on. Low Power Wake-Up Receiver 121 may remain on in order to detect IEEE 802.11 signals corresponding to frames that may cause Low Power Wake-Up Receiver 121 to power on Wi-Fi/BLE Radio 111. Signals may be received by Wi-Fi/BLE Radio 111 and Low Power Wake-Up Receiver 121 via antenna 141.

Mobile phone 104 may be a smart phone comprising a Wi-Fi radio and/or Bluetooth Low Energy (BLE) radio that may transmit and receive signals to wireless device 103. When wireless device 101 transmits signals to wireless devices 103, Wi-Fi/BLE Radio 131 may be powered on if the signals comprise IEEE 802.11 signals corresponding to frames that cause Low Power Wake-Up Receiver 151 to send a power on signal to Wi-Fi/BLE Radio 131. Signals may be received by Wi-Fi/BLE Radio 131 and Low Power Wake-Up Receiver 151 via antenna 161.

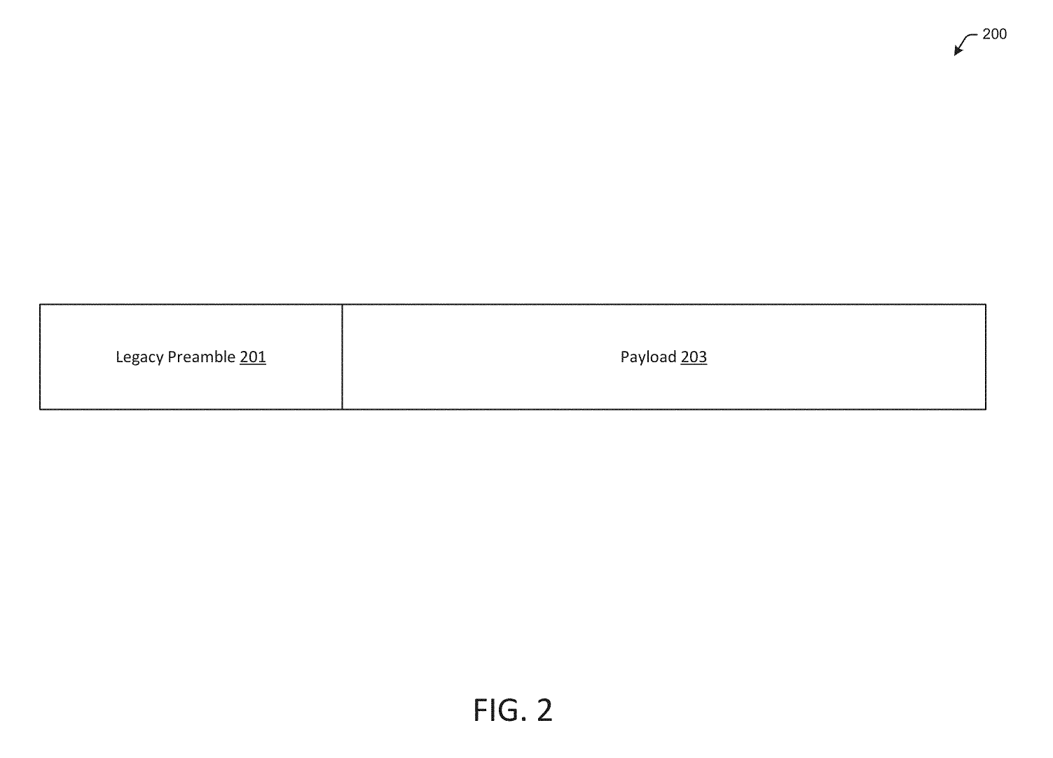

FIG. 2 depicts an illustrative LP-WUR wakeup packet, according to one or more example embodiments of the disclosure. LP-WUR wakeup packet 200 may comprise legacy preamble 201 and payload 203. Legacy Preamble 201 may be a legacy preamble of an IEEE 802.11 packet that may be decoded by wireless devices comprising IEEE 802.11 enabled wireless radios. For example, wireless device(s) 102 and 104 of FIG. 1 may be able to decode legacy preamble 201. Legacy preamble 201 may comprise, among other fields, a signal field that comprises a rate subfield and a length subfield. The rate and length subfields in the signal field may be used to indicate the length of the new wakeup packet for other wireless devices so that they do not attempt to transmit packets during the period when payload 203 is being transmitted which may comprise a wake up signal corresponding to a sequence of bits. Payload 203 may comprise a sequence of bits that may be modulated using an on-off keying (OOK) modulation waveform. Having the legacy preamble 201 in addition to the payload 203 enables low-power wake-up radio to co-exist with legacy radios (e.g., 802.11 radios). For instance, wireless device 104 may transmit LP-WUR wakeup packet 200, wherein payload 203 comprises a sequence of bits corresponding to a wake up (power on) signal wherein each bit is modulated using an OOK modulation. This process, more specifically Low Power Wake-Up Receiver 151 may perform the demodulation and based on the bit sequence Low Power Wake-Up Receiver 151 may transmit a signal to Wi-Fi/BLE Radio 131 that may cause Wi-Fi/BLE Radio 131 to power on.

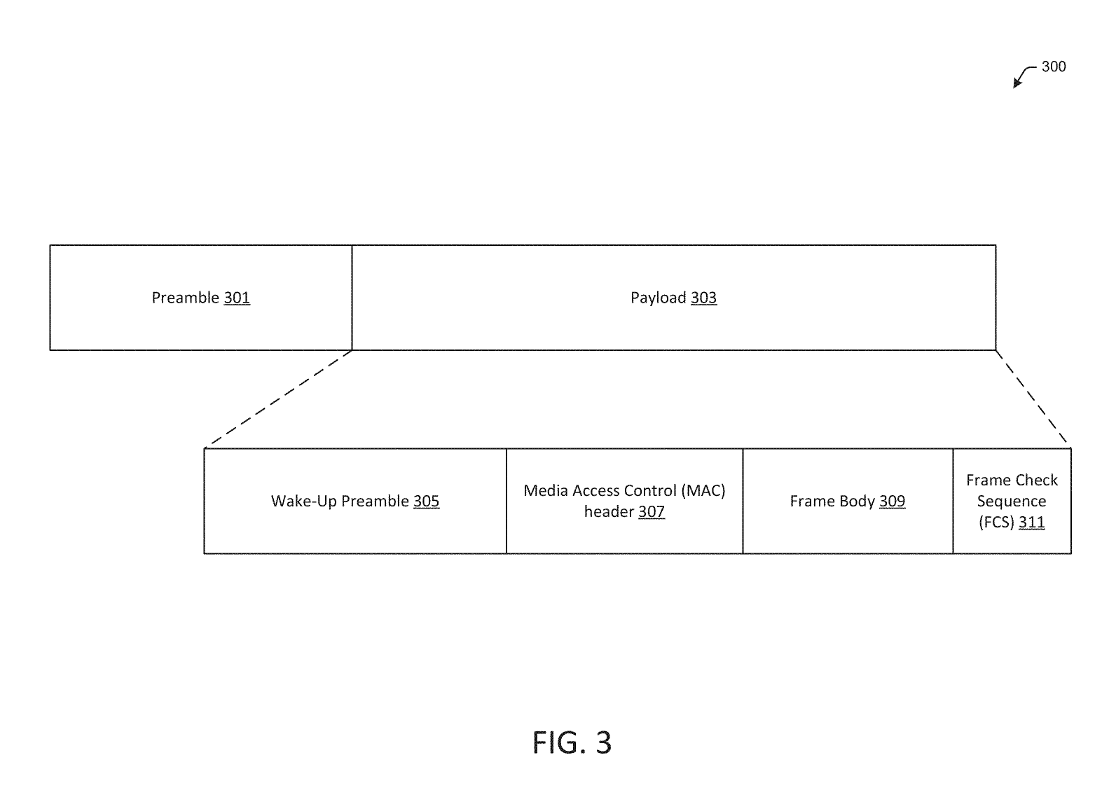

FIG. 3 depicts an illustrative LP-WUR wakeup packet, according to one or more example embodiments of the disclosure. LP-WUR wakeup packet 300 may comprise preamble 301 and payload 303. Preamble 301 may include similar information to that included legacy preamble 201 of FIG. 2, but may be a preamble of device a legacy, high throughput (HT), or very high throughput (VHT) device, based on the signal transmitted corresponding to payload 303. The signal subfield of preamble 301 may also include a packet type subfield indicating the type of the packet. The packet type subfield may use two bits corresponding to four different permutations of two binary digits (e.g., 00, 01, 10, and 11 corresponding to natural numbers 0, 1, 2, and 3 respectively). A packet type subfield value of 0 may indicate to a receiving device that the packet type is a IEEE 802.11 packet, a packet type subfield value of 1 may indicate to the receiving device that the packet type is a wake up packet, a packet type subfield value of 2 may indicate to the receiving device that the packet is an enhanced-wakeup packet, and a packet type subfield value of 3 may be reserved. When the packet type subfield value is equal to 2 the payload 303 may contain both a wakeup signal, corresponding to a sequence of bits that may cause a first wireless device, or more particularly a Low Power Wake-Up Receiver (e.g., Low Power Wake-Up Receiver 151 of FIG. 1) in the wireless device to power on a Wi-Fi/BLE radio (e.g., Wi-Fi/BLE Radio 131 in FIG. 1). Media Access Control (MAC) header 307 may comprise a MAC address receiver (RA) subfield comprising the MAC address of a Low Power Wake-Up Receiver. Frame Body 309 may comprise time information that may be used for scheduling transmission times between a transmitting and receiving device. For example, a wake-up packet may indicate a future time at which a receiving device of the wake-up packet should power on and receive a data packet. Frame Check Sequence (FCS) 311 may comprise a number (FCS number) that is calculated by a transmitting device (e.g., wireless device 104 in FIG. 1) based on data in LP-WUR wakeup packet 300, and in particular payload 303. The FCS number may be added to the end of a frame comprising LP-WUR wakeup packet 300. When a receiving device (e.g., wireless device 101 of FIG. 1) receives the frame the FCS number is recalculated and compared with the FCS number included in the frame. If the recalculated FCS number is not the same as the FCS number transmitted in the frame, an error is determined to have occurred during transmission and the frame is discarded. The transmitting device may compute a cyclic redundancy check on the entire frame and append FCS 311 as a trailer to the data. The receiving device may compute the cyclic redundancy check on the frame using the same algorithm used to generate the cyclic redundancy check, and may compare it to FCS 306. This may enable the receiving device to detect whether any data was lost or altered in transit. In some embodiments, if an error is detected, it may discard the data, and request retransmission of the frame. In some embodiments, FCS 311 may be transmitted in such a way that the receiving device can compute a running sum over the entire frame, together with the trailing FCS, expecting to see a fixed result (such as zero) when it is correct. The fixed result may be a CRC32 residue. When transmitted and used in this way, FCS 311 generally appears immediately before a frame-ending delimiter.

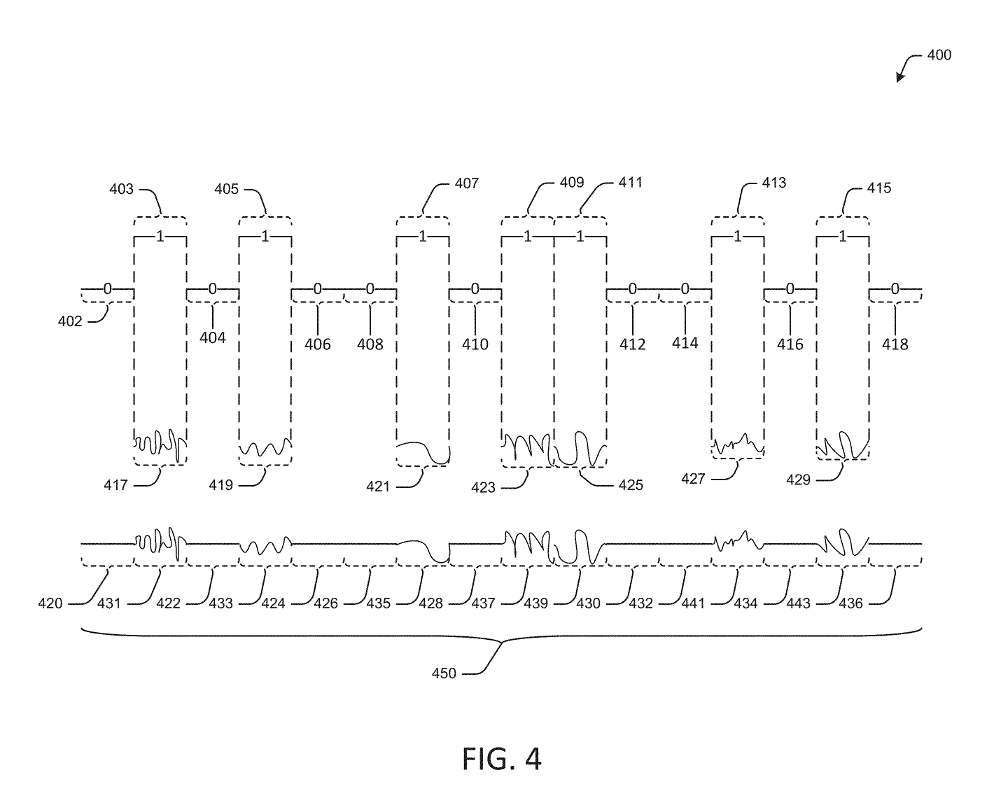

FIG. 4 depicts an illustrative modulation of a wakeup signal with an orthogonal frequency division multiplexing (OFDM) symbol, according to one or more example embodiments of the disclosure. The wakeup signal may correspond to a bit sequence represented by X_{LP}_{_}_{WUR}=[X_{LP}_{_}_{WUR}(n)], where in =1, 2, . . . , N_{LP}_{_}_{WUR}, and N_{LP}_{_}_{WUR} is the length of the wakeup packet in terms of the number of OFDM symbols. That is the cardinality of the set of transmitted OFDM symbols, which is equal to N_{LP}_{_}_{WUR}. When the n^{th} bit value is equal to 1, that is when X_{LP}_{_}_{WUR}(n)=1, an IEEE 802.11 OFDM symbol carrying user data is used to modulate the n^{th} bit. Accordingly, the IEEE 802.11 OFDM symbol may be transmitted during an OFDM symbol duration interval when X_{LP}_{_}_{WUR}(n)=1. Conversely, when X_{LP}_{_}_{WUR}(n)=0, an IEEE 802.11 OFDM symbol is not transmitted during the OFDM symbol duration interval.

In general, an enhanced-wakeup packet 450 may be generated by generating OFDM modulated user data when a bit value of an OOK modulated wakeup signal is equal to 1 (e.g., X_{LP}_{_}_{WUR}(n)=1). The OOK modulated wakeup signal may comprise a plurality of signals in time, each of which may last a certain duration of time, corresponding to an OOK modulated signal value (e.g., a value of “0” or “1”), where the duration of time may be referred to as the OOK symbol duration interval. The OOK symbol duration interval is equal to the OFDM symbol duration interval.

OFDM symbols 417, 419, 421, 423, 425, 427, and 429 may correspond to 7 predetermined symbols that may be used to communicate user data from a transmitting device (e.g., wireless device 104 of FIG. 1) to a receiving device comprising a Wi-Fi/BLE radio (e.g., wireless device 102 in FIG. 1), while a wakeup signal is simultaneously being transmitted to Low Power Wake-Up Receiver (e.g., Low Power Wake-Up Receiver 151 in FIG. 1), wherein the user data and wake up signal are included in the same wakeup packet (e.g., LP-WUR wakeup packet 300 in FIG. 3).

As an example, OOK symbols 402, 403, 404, 405, 407, 406, 408, 410, 409, 411, 412, 414, 413, 416, 415, and 418 may each represent a bit, corresponding to a wakeup signal. That is OOK symbol 402 may represent a bit value of “0”, OOK symbol 403 may represent a bit value of “1”, OOK symbol 404 may represent a bit value of “1”, OOK symbol 405 may represent a bit value of “1”, OOK symbol 406 and 408 may each represent a bit value of “0”, OOK symbol 407 may represent a bit value of “1”, OOK symbol 410 may represent a bit value of “0”, OOK symbols 409 and 411 may each represent a bit value of “1”, OOK symbols 412 and 414 may each represent a bit value of “0”, OOK symbol 413 may represent a bit value of “l”, OOK symbol 416 may represent a bit value of “0”, OOK symbol 415 may represent a bit value of “l”, and OOK symbol 418 may represent a bit value of “0”. Because the OOK symbol duration interval is the same as the OFDM symbol duration interval, the enhanced wakeup packet 450 may be formed by generating an OFDM modulated user data whenever the bit value of the OOK modulated wakeup signal is 1. Since the OOK modulate wakeup signal is equal to 1 during 403, 405, 407, 409, 411, 413, and 415, and equal to 0 during 402, 404, 406, 408, 410, 412, 414, 416, and 418, the enhanced wakeup packet 450 comprises symbols 420, 431, 422, 433, 424, 426, 435, 428, 437, 439, 430, 432, 441, 434, 443, and 436 respectively. That is the payload may be represented by signals 420, 431, 422, 433, 424, 426, 435, 428, 437, 439, 430, 432, 441, 434, 443, and 436, which contain the wakeup signal modulated by the user data.

In some embodiments, a radio associated with the transmitting device of the wakeup packet may determine when an OOK symbol is equal to “1” and may simply transmit an OFDM symbol during the OFDM symbol duration interval.

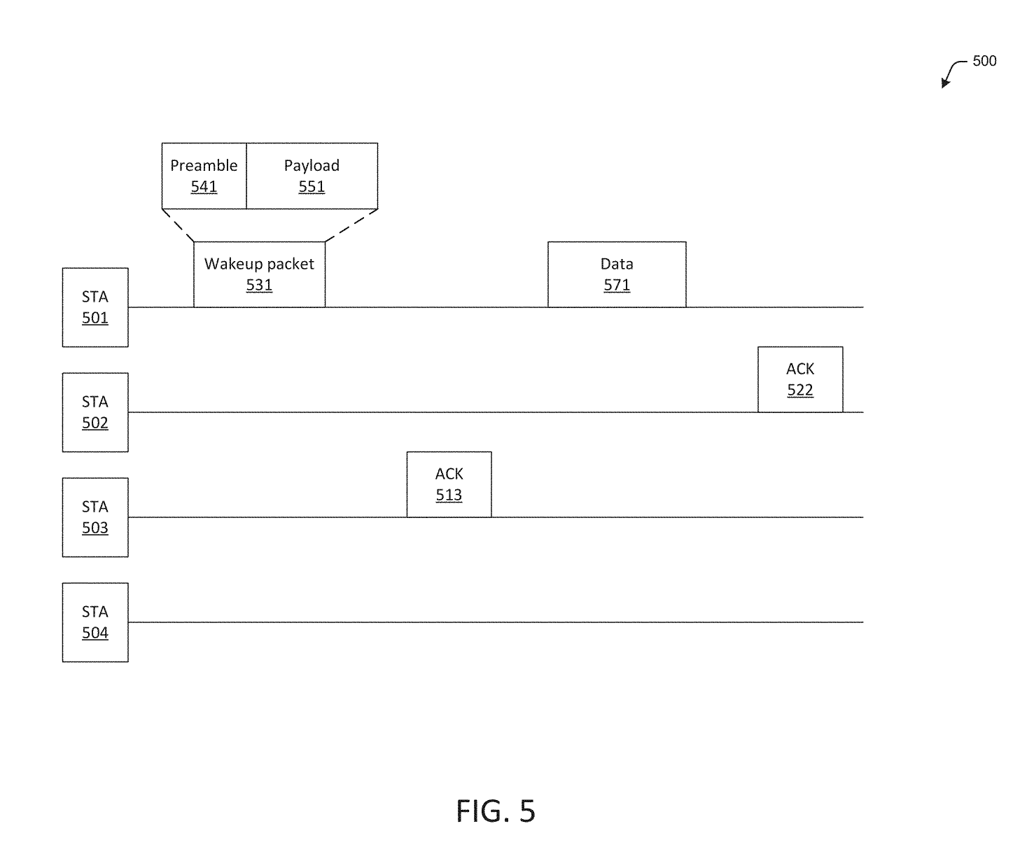

FIG. 5 depicts an illustrative timing diagram of the transmission of a LP-WUR to LP-WURs and non-LP-WURs, according to one or more example embodiments of the disclosure. STAs 501, 502, 503, and 504 may comprise Wi-Fi/BLE radios, Low Power Wake-Up Receivers, or a combination of the two. For example, STA 501 may comprise a Wi-Fi/BLE radio, STA 502 may comprise a Wi-Fi/BLE radio and Low Power Wake-Up Receiver, and STAs 503 and 504 may each comprise a Wi-Fi/BLE radio. STA 501 may have a data packet (first data packet) for STA 502, wherein STA 502's Wi-Fi/BLE radio is powered off and its Low Power Wake-Up Receiver is powered on and set to receive a wake up packet (e.g., Wakeup packet 531). STA 501 may also have a data packet (second data packet) for STA 503, and STA 503's Wi-Fi/BLE radio may be powered on and set to receive the second data packet.

STA 501 may transmit an enhanced-wakeup packet (e.g., a wakeup packet 531 with packet type subfield value equal to 2), which may comprise, in a payload field (e.g., Payload 551) of the enhanced-wakeup packet, a sequence of bits (OOK symbols) corresponding to a wake up signal (OOK modulated wakeup signal). The enhanced wakeup packet overlays or otherwise encode the OFDM modulated data signal for STA 503 and OOK modulated wakeup signal for STA 502. Because the preamble (e.g., Preamble 541) in an enhanced wakeup packet comprises a signal field that further comprises length field, when STAs 503 and 504 receive a packet (e.g., the enhanced-wakeup packet), they may determine the length and type of the received packet. If the received packet is a wakeup packet, STAs 503 and 504 may defer channel access until STA 501 has completed transmission of the wakeup packet. If the received packet is a regular 802.11 packet, the STAs 503 and 504 may receive and further process the received packet if they are the intended receivers of the packet. STA 503 and STA 504 may determine that the wakeup packet is an enhanced-wakeup packet based on the signal field of the preamble and may demodulate the OFDM symbols of a received signal corresponding to the wakeup packet. STAs 503 and 504 may use OOK demodulation to determine which OFDM symbol to demodulate and decode. For example, if the OOK demodulation results indicate that “1” has been received during an OOK symbol duration interval, an OFDM demodulator in STAs 503 and 504 may demodulate the OFDM symbol and process the OFDM symbol to decode user data that was encoded in the OFDM symbol. If the receiver address field of the decoded user data matches the MAC address of STA 503 and the wakeup packet is received by STA 503 without any errors, then STA 503 may transmit an acknowledgment (ACK) frame 513 to STA 501.

The Low Power Wake-Up Receiver of STA 502 may detect a wakeup preamble (e.g., Wake-Up Preamble 305) in the payload (e.g., Payload 551) of the wakeup packet (e.g., wakeup packet 531), and may determine the beginning of a wakeup frame which may begin with a MAC header field (e.g., MAC header 307 in FIG. 3). If the receiver address field of the MAC header field of the enhanced-wakeup packet matches the MAC address of STA 502, STA 502's Low Power Wake-Up Receiver may transmit a signal to its Wi-Fi/BLE radio to power it on.

STA 501 may transmit the first data packet to STA 502 at a predetermined time interval (e.g., a short interframe space (SIFS)) after the ACK frame is received from STA 503. After receiving the first data packet from STA 501, STA 502 may transmit an ACK frame 522 to STA 501.

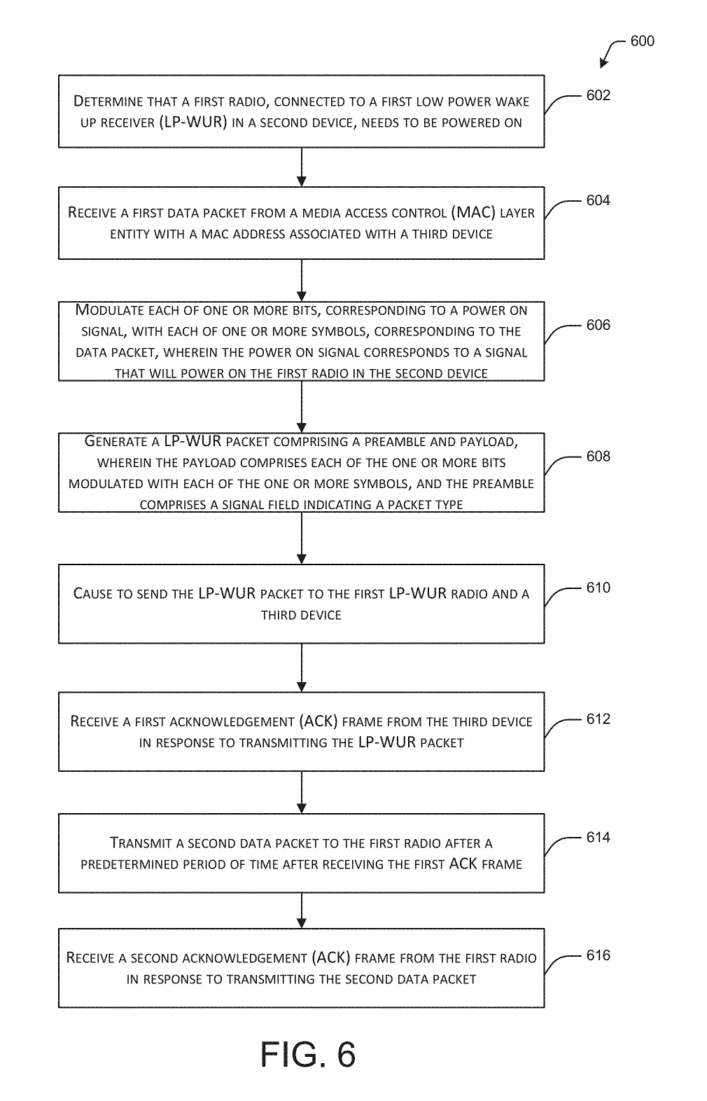

FIG. 6 depicts an illustrative flow diagram for encapsulating a frame, according to one or more example embodiments of the disclosure. Method 600 may correspond to a series of steps that may occur in the order depicted in method 600 or in another order, and may correspond to computer-executable instructions that may be executed by a processor or one or more components in a wireless device, such as STA 501 in FIG. 5. At step 602, the method may determine that a first radio (e.g., Wi-Fi/BLE 131 in FIG. 1), connected to a first low power wake up radio (LP-WUR) (e.g., Low Power Wake-Up Receiver 151 in FIG. 1) in a second device (e.g., wireless device 103 in FIG. 1), needs to be powered on. At step 604, the method may receive a first data packet from a media access control (MAC) layer entity with a MAC address associated with a third device. At step 606, the method may modulate each of one or more bits, corresponding to a power on signal, with each of one or more symbols, corresponding to the data packet, wherein the power on signal corresponds to a signal that will power on the first radio in the second device. At step 608, the method may generate the LP-WUR packet comprising a preamble and payload, wherein the payload comprises each of the one or more bits modulated with each of the one or more symbols, and the preamble comprises a signal field indicating a packet type. At step 610, the method may cause to send the LP-WUR packet to the first LP-WUR radio and the third device. At step 612, the method may receive a first acknowledgment (ACK) frame from the third device in response to transmitting the LP-WUR packet. At step 614, the method may transmit a second data packet to the first radio after a predetermined period of time after receiving the first ACK frame. At step 616, the method may receive a second acknowledgement (ACK) frame from the first radio in response to transmitting the second data packet.

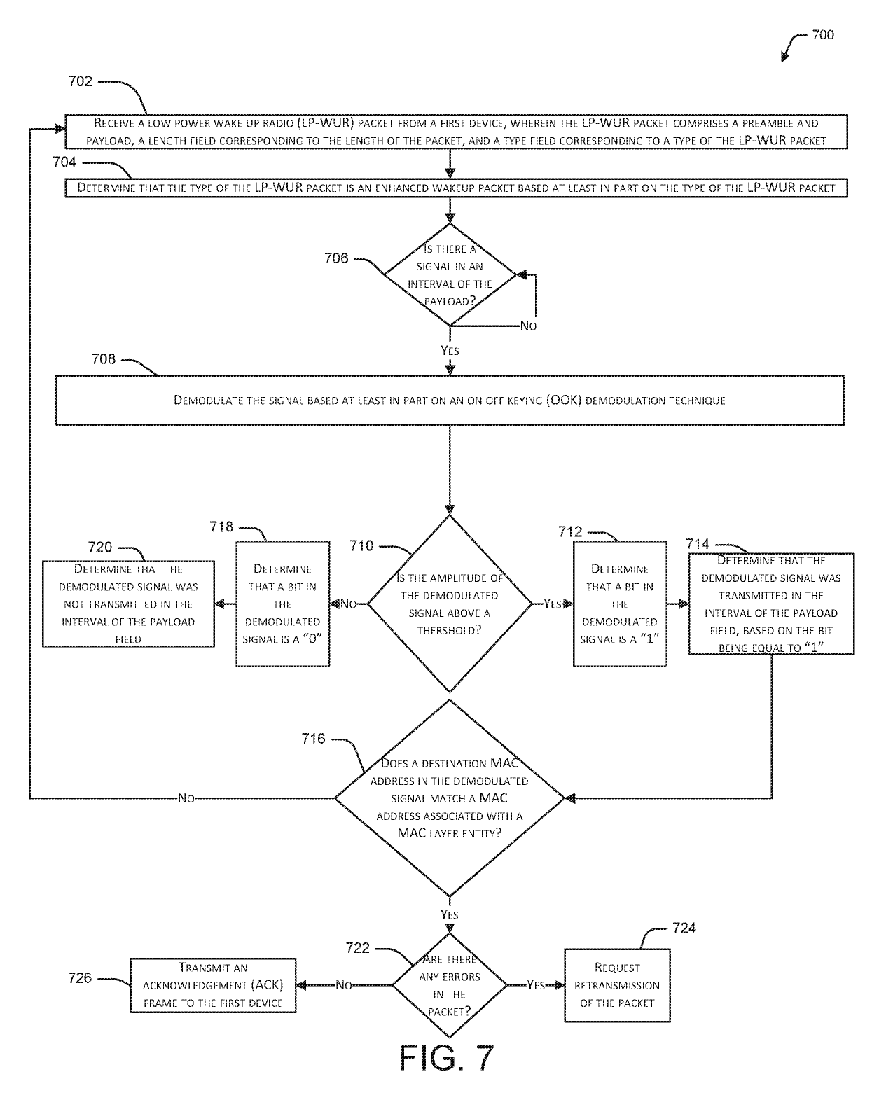

FIG. 7 depicts an illustrative flow diagram for encapsulating a frame, according to the disclosure. Method 700 may correspond to a series of steps that may occur in the order depicted in method 700 or in another order, and may correspond to computer-executable instructions that may be executed by a processor or one or more components in a wireless device, such as STA 502 in FIG. 5. At step 702, the method may receive a low power wake up radio (LP-WUR) packet from a first device, wherein the LP-WUR comprises a preamble and payload, a length field corresponding to the length of the packet, and a type field corresponding to a type of the LP-WUR packet. At step 704, the method may determine that the type of the LP-WUR packet is an enhanced wakeup packet based at least in part on the type of the LP-WUR packet. At step 707, the method may determine if there is a signal in an interval (e.g., OOK symbol duration interval which may be the same as the OFMD symbol duration interval) of the payload. If not the method may remain at step 702 until the method determines that there is a signal in an interval of the payload. If the method determines that there is a signal in an interval of the payload, the method may progress to step 708. At step 708 the method may demodulate the signal based at least in part on an on off keying (OOK) demodulation technique. At step 710, the method may sample the demodulated signal and determine if the amplitude of the sampled demodulated signal is above a threshold. If the method determines that the sampled demodulated signal is above the threshold (YES), the method may progress to step 712 wherein the method may determine that the bit is a “1”. If the method determines that the amplitude of the sampled demodulated signal is not above the threshold (NO), the method may progress to step 718 and determine that the bit is a “0”. At step 720, the method may determine that the demodulated signal was not transmitted in the interval of the payload field. If the method determines that the bit is a “1”, the method may then progress to step 714 and determine that the demodulated signal was transmitted in the interval of the payload field. At step 716, the method may determine if a destination MAC address in the demodulated signal matches a MAC address associated with a MAC layer entity. If the method determines that it does match (YES) the method may progress to step 722. If the method determines that it does not match (NO) the method may return to step 702. At step 722, the method may determine if there are any errors in the packet. If the method determines that there are no errors in the packet (NO), the method may progress to step 726 and may transmit an acknowledgment (ACK) frame to the first device. If the method determines that there are errors in the packet the method may progress to step 724 and request retransmission of the packet.

It should be noted that, the sampled demodulated signal may comprise a portion of user data (e.g., data associated with an application executing on STA 502 in FIG. 5) that is received from STA 501 in FIG. 5. For example a Voice over Internet Protocol (VoIP) application could be executing on STA 502 in FIG. 5 and may receive data packets associated with voice signals from STA 501 in FIG. 5. Each packet may comprise a plurality of signals, each occupying an interval in the packet, and therefore each sampled demodulated signal may correspond to a portion of sampled voice data from STA 501 in FIG. 5. Because steps 706-726 illustrate the method operating on a signal in an interval, steps 706-726 may be executed a plurality of times depending on the length of the payload of the packet. For example, if the length of the payload corresponds to 100 signal intervals steps 706-726 may be traversed 100 times.

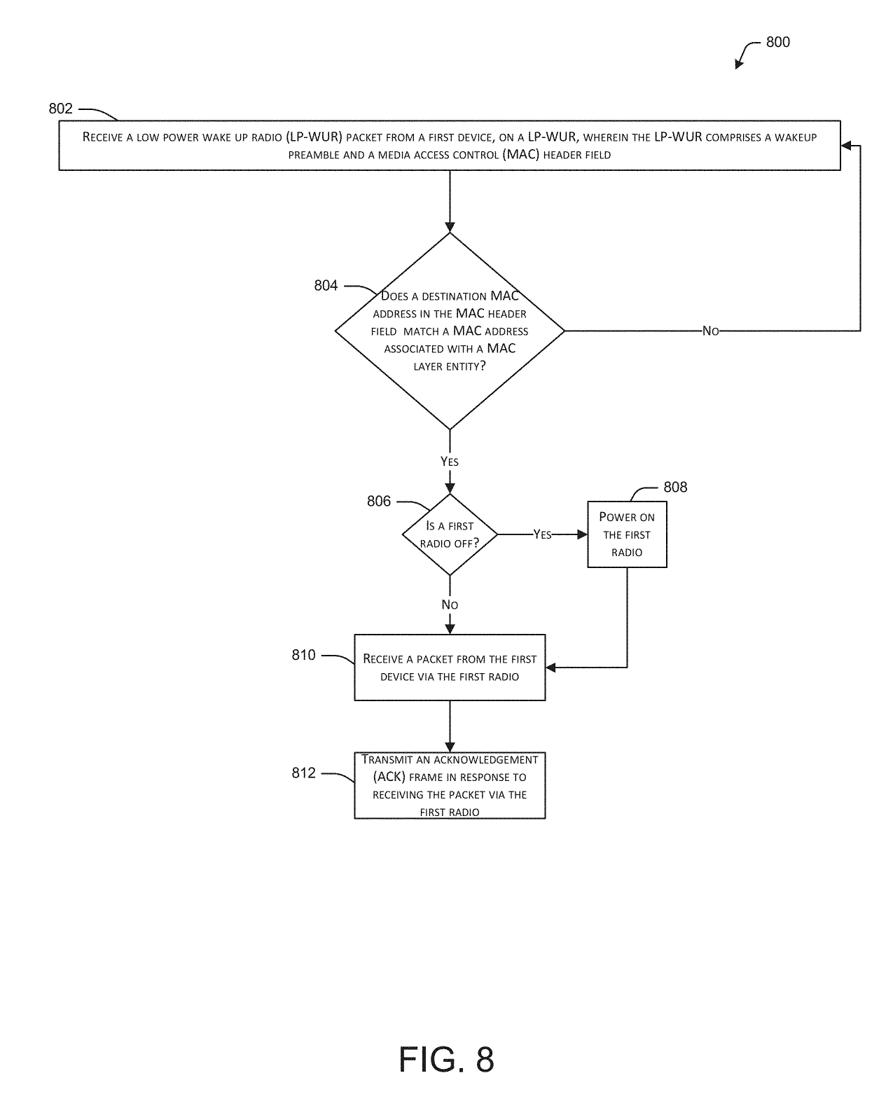

FIG. 8 depicts an illustrative flow diagram for ordering packets, according to the disclosure. Method 800 may correspond to a series of steps that may occur in the order depicted in method 800 or in another order, and may correspond to computer-executable instructions that may be executed by a processor or one or more components in a wireless device, such as STA 503 in FIG. 5, which may be a mobile device such as wireless device 104. At step 802, the method receives a low power wake up radio (LP-WUR) packet from a first device, on a LP-WUR, wherein the LP-WUR comprises a wakeup preamble and a media access control (MAC) header field. At step 804, the method may determine if a destination MAC address in the MAC header field matches a MAC address associated with a MAC layer entity. If the method determines that the destination MAC address in the MAC header field does not match the MAC address associated with the MAC layer entity (NO), the method may return to step 802. If the method determines that the destination MAC address in the MAC header field does match the MAC address associated with the MAC layer entity (YES), the method may progress to step 806. At step 806, the method may determine if a first radio is off (e.g., Wi-Fi/BLE Radio 131 in FIG. 1). If the first radio is off, the method may progress to step 808 and power on the first radio. If the first radio is on, the method may progress to step 810 and the method may receive a packet from the first device via the first radio. At step 812, the method may transmit an acknowledgment (ACK) frame in response to receiving the packet via the first radio.

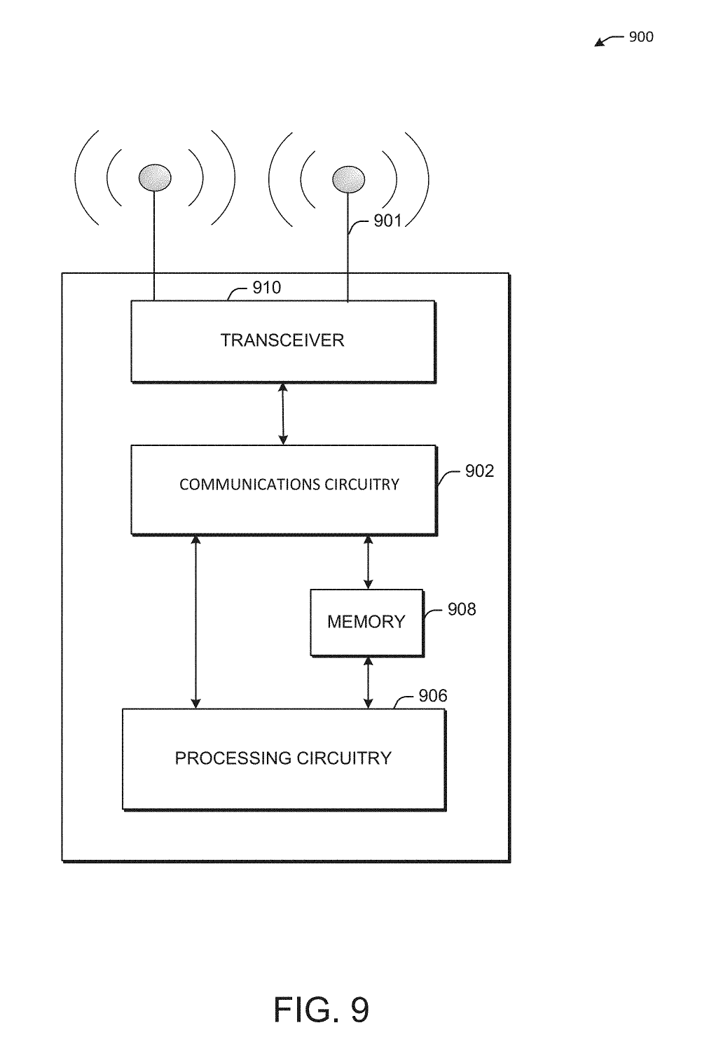

FIG. 9 shows a functional diagram of an exemplary communication station 900 in accordance with some embodiments. In one embodiment, FIG. 9 illustrates a functional block diagram of a communication station that may be suitable for use as an AP (e.g., APs 102, 104, 108, 110) in FIG. 1 or at least one user device (e.g., user device 114) in FIG. 1 in accordance with some embodiments. The communication station 900 may also be suitable for use as a handheld device, mobile device, cellular telephone, smartphone, tablet, netbook, wireless terminal, laptop computer, wearable computer device, femtocell, HiGH Data Rate (HDR) subscriber station, access point, access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform operations detailed in FIGS. 6-8.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (for example, a computer). For example, the memory 908 may include a computer-readable storage device may, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (for example, a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 900 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (for example, a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device memory.

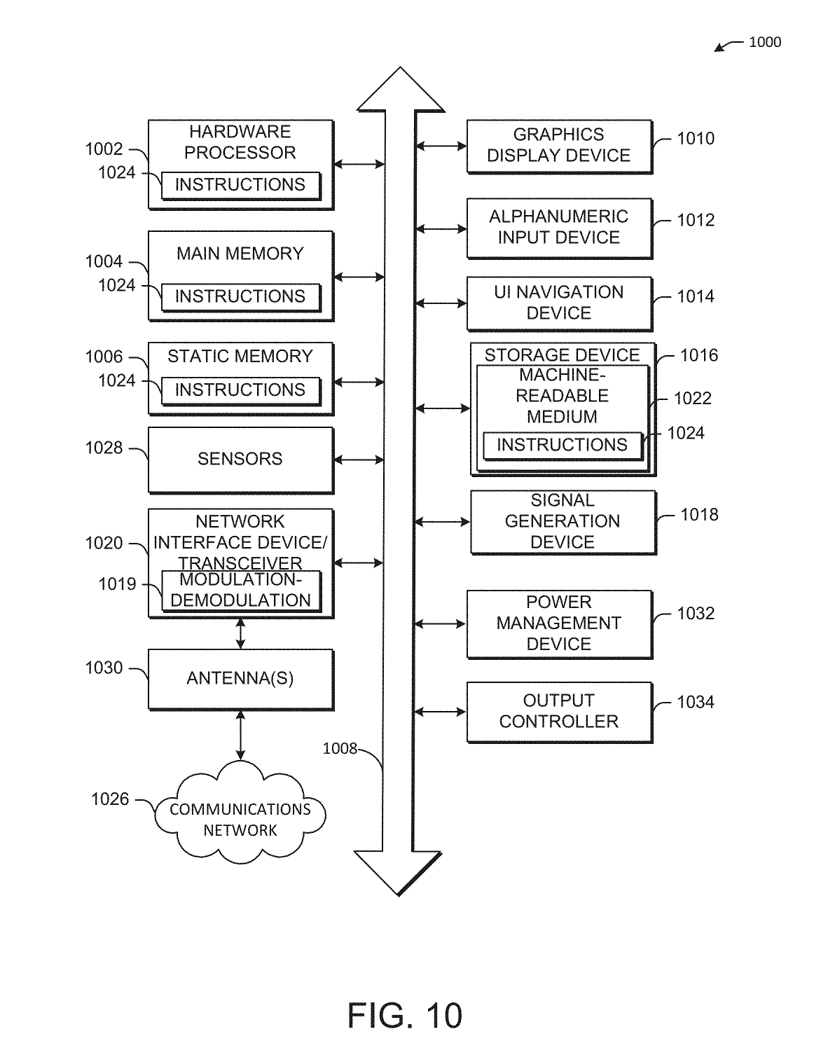

FIG. 10 illustrates a block diagram of an example of a machine 1000 or system upon which any one or more of the techniques (for example, methodologies) discussed herein may be performed. In other embodiments, the machine 1000 may operate as a standalone device or may be connected (for example, networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environments. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (for example, hardware) capable of performing specified operations when operating. A module includes hardware. In an example, the hardware may be specifically configured to carry out a specific operation (for example, hardwired). In another example, the hardware may include configurable execution units (for example, transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (for example, computer system) 1000 may include a hardware processor 1002 (for example, a central processing unit (CPU), a graphics processing unit (GPU), a hardware processor core, or any combination thereof), a main memory 1004 and a static memory 1006, some or all of which may communicate with each other via an interlink (for example, bus) 1008. The machine 1000 may further include a power management device 1032, a graphics display device 1010, an alphanumeric input device 1012 (for example, a keyboard), and a user interface (UI) navigation device 1014 (for example, a mouse). In an example, the graphics display device 1010, alphanumeric input device 1012, and UI navigation device 1014 may be a touch screen display. The machine 1000 may additionally include a storage device (i.e., drive unit) 1016, a signal generation device 1018 (for example, a speaker), a modulation-demodulation device 1019, a network interface device/transceiver 1020 coupled to antenna(s) 1030, and one or more sensors 1028, such as a global positioning system (GPS) sensor, compass, accelerometer, or other sensor. The machine 1000 may include an output controller 1034, such as a serial (for example, universal serial bus (USB), parallel, or other wired or wireless (for example, infrared (IR), near field communication (NFC), etc.) connection to communicate with or control one or more peripheral devices (for example, a printer, card reader, etc.)).

The storage device 1016 may include a machine readable medium 1022 on which is stored one or more sets of data structures or instructions 1024 (for example, software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

Modulation-demodulation device 1019 may carry out or perform any of the operations and processes (e.g., processes 600, 700, and 800) described and shown above. For example, modulation-demodulation device 1019 may be configured to modulate a LP-WUR wake up bit sequence with orthogonal frequency division multiplexing (OFDM) symbols using an OOK modulation technique and/or demodulate a LP-WUR wake up bit sequence with orthogonal frequency division multiplexing (OFDM) symbols using an OOK modulation technique. Modulation-demodulation device 1019 may also simply modulate OFDM symbols corresponding to the IEEE 802.11 standard and transmit them in a packet or transmit LP-WUR packets without a modulated OFDM symbol. Modulation-demodulation 1019 may also work in conjunction with a media access control (MAC) device in network interface device/transceiver 1020 to add a preamble comprising, among other things a packet type subfield. The preamble may be added to each outgoing frame, and each outgoing frame may comprise a packet. As explained above the packet type subfield may indicate whether a LP-WUR packet is included in a payload field of the frame, wherein the payload field carries the LP-WUR packet. The packet type subfield may also indicate whether an 802.11 packet is contained in the payload field. The packet type subfield may also indicate whether an enhanced LP-WUR packet is contained in the payload field.

It is understood that the above are only a subset of what modulation-demodulation device 1019 may be configured to perform and that other functions included throughout this disclosure may also be performed by modulation-demodulation device 1019.

The instructions 1024 may carry out or perform any of the operations and processes (for example, processes 300-1300) described and shown above. While the machine-readable medium 1022 is illustrated as a single medium, the term “machine-readable medium” may include a single medium or multiple media (for example, a centralized or distributed database, and/or associated caches and servers) configured to store the one or more instructions 1024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (for example, Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (for example, frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (for example, the Internet), mobile telephone networks (for example, cellular networks), Plain Old Telephone (POTS) networks, wireless data networks (for example, Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (for example, Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000 and includes digital or analog communications signals or other intangible media to facilitate communication of such software. The operations and processes (for example, processes 600-900) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, HiGH Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a wireless device, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, for example, a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), time-Division Multiplexing (TDM), time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced. Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

In example embodiments of the disclosure, there may be a device, comprising a memory and processing circuitry configured to: receive a packet from a first device, wherein the packet comprises a preamble and a payload field, wherein the preamble comprises a length field and type field corresponding to a packet type; determine at least one interval of the payload, and a signal in the at least one interval; demodulate the signal based at least in part on an on off keying (OOK) demodulation; determine that an amplitude of the demodulated signal is above a threshold; determine that a bit associated with the demodulated signal is equal to a value; determine that the demodulated signal was transmitted in the interval of the payload field, based at least in part on the bit being equal to the value; decode and orthogonal frequency division multiplexing (OFDM) symbol in the demodulated signal; and transmit an acknowledgment (ACK) frame to the first device.

Implementations may include the following features. The packet type may be an enhanced wakeup packet. The packet may be an 802.11 packet. The processing circuitry may be further configured to determine that the packet type is an enhanced wakeup packet based at least in part on a packet subfield in the packet being equal to a first value. The processing circuitry may be further configured to determine that the packet type is an 802.11 packet based at least in part on a packet subfield being equal to a second value. The device may further comprise at least one transceiver. The at least one transceiver may have an antenna coupled to it.

In example embodiments of the disclosure, there may be a non-transitory computer-readable medium storing computer-executable instructions which, when executed by a processor, cause the processor to perform operations comprising: receiving a packet from a first device, wherein the packet comprises a preamble and a payload field, wherein the preamble comprises a length field and type field corresponding to a packet type; determining that there is at least one interval of the payload, and a signal in the at least one interval; demodulating the signal based at least in part on an on off keying (OOK) demodulation; determining that an amplitude of the demodulated signal is above a threshold; determining that a bit associated with the demodulated signal is equal to a value; determining that the demodulated signal was transmitted in the interval of the payload field, based at least in part on the bit being equal to the value; decoding and orthogonal frequency division multiplexing (OFDM) symbol in the demodulated signal; and transmitting an acknowledgment (ACK) frame to the first device.

Implementations may include the following features. The packet type may be an enhanced wakeup packet. The packet type may be an 802.11 packet. The computer-executable instructions, which when executed by the processor, may further cause the processor to perform the operations comprising determining that the packet type is an enhanced wakeup packet based at least in part on a packet subfield in the packet being equal to a first value. The computer-executable instructions, which when executed by the processor, may further cause the processor to perform the operations comprising determining that the packet type is an 802.11 packet based at least in part on a packet subfield being equal to a second value.

In example embodiments of the disclosure, there may be a device comprising memory and processing circuitry configured to: determine that a first radio, connected to a first low power wake up receiver (LP-WUR) in a second device is to be powered on; modulate a bit corresponding to a power on signal with an orthogonal frequency division multiplexing (OFDM) symbol corresponding to data packet, wherein the power on signal corresponds to a signal that will power on the first radio in the second device; generate a LP-WUR packet comprising a preamble and payload, wherein the payload comprises the bit modulated with the symbol, and the preamble comprises a signal field indicating the packet type; and cause to send the LP-WUR packet to the first LP-WUR radio and a third device.

Implementations may include the following features. The LP-WUR packet may further comprise a packet type subfield. The processing circuity may be further configured to set the packet type subfield to a first value corresponding to the LP-WUR. The processing circuitry may be further configured to modulate bit with the OFDM symbol using an on off keying (OOK) demodulation. The processing circuity maybe further configured to set the packet type subfield to the first value based at least in part on the determination that the first radio is to be powered on. The device may further comprise at least one transceiver and at least one antenna coupled to the at least one transceiver. The bit may be included in a sequence of bits comprising a media access control (MAC) address of the LP-WUR, and the OFDM symbol may be included in a sequence of OFDM symbols comprising a MAC address of the third device.

Conditional

language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising:
memory and processing circuitry configured to:
receive a packet from a first device, wherein the packet comprises a preamble and a payload field, wherein the preamble comprises a length field and type field corresponding to a packet type;
determine at least one interval of the payload, and a signal in the at least one interval;
demodulate the signal based at least in part on an on off keying (OOK) demodulation;
determine that an amplitude of the demodulated signal is above a threshold;
determine that a bit associated with the demodulated signal is equal to a value;
determine that the demodulated signal was transmitted in the interval of the payload field, based at least in part on the bit being equal to the value;
decode and orthogonal frequency division multiplexing (OFDM) symbol in the demodulated signal; and
transmit an acknowledgment (ACK) frame to the first device.

2. The device of claim 1, wherein the packet type is an enhanced wakeup packet.

3. The device of claim 1, wherein the packet type is an 802.11 packet.

4. The device of claim 2, wherein the processing circuity is further configured to:
determine that the packet type is an enhanced wakeup packet based at least in part on a packet subfield in the packet being equal to a first value.

5. The device of claim 3, wherein the processing circuity is further configured to:
determine that the packet type is an 802.11 packet based at least in part on a packet subfield being equal to a second value.

6. The device of claim 1, further comprising at least one transceiver.

7. The device of claim 6, further comprising at least one antenna coupled to the at least one transceiver.

8. A non-transitory computer-readable medium storing computer-executable instructions which, when executed by a processor, cause the processor to perform operations comprising:
receiving a packet from a first device, wherein the packet comprises a preamble and a payload field, wherein the preamble comprises a length field and type field corresponding to a packet type;
determining that there is at least one interval of the payload, and a signal in the at least one interval;
demodulating the signal based at least in part on an on off keying (OOK) demodulation;
determining that an amplitude of the demodulated signal is above a threshold;
determining that a bit associated with the demodulated signal is equal to a value;
determining that the demodulated signal was transmitted in the interval of the payload field, based at least in part on the bit being equal to the value;
decoding and orthogonal frequency division multiplexing (OFDM) symbol in the demodulated signal; and
transmitting an acknowledgment (ACK) frame to the first device.

9. The non-transitory computer-readable medium of claim 8, wherein the packet type is an enhanced wakeup packet.

10. The non-transitory computer-readable medium of claim 8, wherein the packet type is an 802.11 packet.

11. The non-transitory computer-readable medium of claim 9, wherein the computer-executable instructions, which when executed by the processor, further cause the processor to perform the operations comprising:
determining that the packet type is an enhanced wakeup packet based at least in part on a packet subfield in the packet being equal to a first value.

12. The non-transitory computer-readable medium of claim 10, wherein the computer-executable instructions, which when executed by the processor, further cause the processor to perform the operations comprising:
determining that the packet type is an 802.11 packet based at least in part on a packet subfield being equal to a second value.

13. A device, the device comprising:
memory and processing circuitry configured to:
determine that a first radio, connected to a first low power wake up receiver (LP-WUR) in a second device is to be powered on;
modulate a bit corresponding to a power on signal with an orthogonal frequency division multiplexing (OFDM) symbol corresponding to data packet, wherein the power on signal corresponds to a signal that will power on the first radio in the second device;
generate a LP-WUR packet comprising a preamble and payload, wherein the payload comprises the bit modulated with the symbol, and the preamble comprises a signal field indicating the packet type; and
cause to send the LP-WUR packet to the first LP-WUR radio and a third device.

14. The device of claim 13, wherein the LP-WUR packet further comprises a packet type subfield.

15. The device of claim 14, wherein the processing circuity is further configured to:
set the packet type subfield to a first value corresponding to the LP-WUR.

16. The device of claim 13, wherein the processing circuitry is further configured to:
modulate bit with the OFDM symbol using an on off keying (OOK) demodulation.

17. The device of claim 15, wherein the processing circuitry is further configured to:
set the packet type subfield to the first value based at least in part on the determination that the first radio is to be powered on.

18. The device of claim 13, further comprising at least one transceiver.

19. The device of claim 18, further comprising at least one antenna coupled to the at least one transceiver.

20. The device of claim 13, wherein the bit is included in a sequence of bits comprising a media access control (MAC) address of the LP-WUR, and the OFDM symbol is included in a sequence of OFDM symbols comprising a MAC address of the third device.
